(19) United States
(12) Patent Application Publication
(10) Pub. No.: US 2013/0219365 A1
(43) Pub. Date: Aug. 22, 2013

(54) METHOD AND SYSTEM FOR VISUAL FEEDBACK

(71) Applicants: Carlo RAGO, Baltimore, MD (US); Anindo Bandyopadhyay, Bangalore (IN)

(72) Inventors: Carlo RAGO, Baltimore, MD (US); Chris Bunnell, Old Orchard Beach, ME (US); Anindo Bandyopadhyay, Bangalore (IN)

(21) Appl. No.: 13/465,760

(22) Filed: May 7, 2012

Related U.S. Application Data
(60) Provisional application No. 61/482,964, filed on May 5, 2011.

(51) Int. Cl. G06F 11/36

(52) U.S. Cl. CPC G06F 11/362
USPC 717/125

(57) ABSTRACT

An apparatus, method, and system for visual feedback are disclosed. The apparatus, method, and system may include a module for detecting a first feedback trigger designating a first area including at least one pixel, capturing a screenshot including at least the first area, generating a workspace including the screenshot, generating a first design element anchored to the first area within the workspace, receiving an input in or a modification of the first design element, detecting a workspace submission trigger, and transmitting the workspace including the first area and the first design element to a remote server.

### CLAIM OF PRIORITY UNDER 35 U.S.C. §119

This application claims the benefit of and priority to U.S. Provisional Patent Application No. 61/482,964, titled “Method and System for Data Management and Development-Cycle Optimization,” filed May 5, 2011, the disclosure of which is hereby incorporated in its entirety by reference herein.

### BACKGROUND

1. Field

Aspects of the present invention generally relate to error and bug reporting systems, and more particularly to methods and systems for visual feedback for facilitating debugging of software.

2. Introduction

Software or website development typically involves a debugging phase. To communicate with the developers, users who are testing and debugging the product would often times have to laboriously describe in a communication with the developer the issues the user is experiencing with the product. This process of reporting software bugs and errors is very time consuming and inefficient.

Therefore, there exists an unmet need in the art for a system and method for providing visual feedback to developers during the debugging phase in a quick and efficient manner.

### SUMMARY

According to an aspect of the present invention, a method for visual feedback, may include detecting a first feedback trigger designating a first area including at least one pixel, capturing a screenshot including at least the first area, generating a workspace including the screenshot, generating a first design element anchored to the first area within the workspace, receiving an input in or a modification of the first design element, detecting a workspace submission trigger, and transmitting the workspace including the first area and the first design element to a remote server.

According to another aspect of the present invention, an apparatus may include a feedback module configured to detect a first feedback trigger designating a first area including at least one pixel, capture a screenshot including at least the first area, generate a workspace including the screenshot, generate a first design element anchored to the first area within the workspace, receive an input in or a modification of the first design element, detect a workspace submission trigger, and transmit the workspace including the first area and the first design element to a remote server.

According to yet another aspect of the present invention, a system may include means for detecting a first feedback trigger designating a first area including at least one pixel, means for capturing a screenshot including at least the first area, means for generating a workspace including the screenshot, means for generating a first design element anchored to the first area within the workspace, means for receiving an input in or a modification of the first design element, means for detecting a workspace submission trigger, and means for transmitting the workspace including the first area and the first design element to a remote server.

According to yet another aspect of the present invention, a computer program product including a non-transitory computer-readable medium having control logic stored therein for causing a computer to perform visual feedback, the control logic may include code for detecting a first feedback trigger designating a first area including at least one pixel, code for capturing a screenshot including at least the first area, code for generating a workspace including the screenshot, code for generating a first design element anchored to the first area within the workspace, code for receiving an input in or a modification of the first design element, code for detecting a workspace submission trigger, and code for transmitting the workspace including the first area and the first design element to a remote server.

It is understood that other aspects of the invention will become readily apparent to those skilled in the art from the following detailed description, wherein various aspects of the present invention are shown and described by way of illustration only. As will be understood, the present invention is capable of other and different variations and its several details are capable of modification in various other respects, all without departing from the scope of the invention. Accordingly, the drawings and detailed description are to be regarded as illustrative in nature and not as restrictive.

### BRIEF DESCRIPTION OF THE DRAWINGS

These and other sample aspects of the disclosure will be described in the detailed description and the appended claims that follow, and in the accompanying drawings, wherein:

FIG. 1 is an example block diagram illustrating a simplified system for visual feedback in accordance with aspects of the present invention;

FIG. 2 illustrates an example flow diagram of a method for visual feedback in accordance with aspects of this invention;

FIG. 3 depicts a computer system for implementing various aspects of the present invention; and

FIG. 4 is a block diagram of various exemplary system components, in accordance with aspects of the present invention.

In accordance with common practice, the various features illustrated in the drawings may be simplified for clarity. Thus, the drawings may not depict all of the components of a given apparatus or method. In addition, like reference numerals may be used to denote like features throughout the specification and figures.

### DETAILED DESCRIPTION

Various aspects of the present invention are described below. It should be apparent that the teachings herein may be embodied in a wide variety of forms and that any specific structure, function, or both being disclosed herein may be merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality, in addition to or other than one or more of the aspects set forth herein. An aspect may comprise one or more elements of a claim.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem.

Various aspects of the present invention solve the above-identified needs, as well as others, via devices, methods, and systems capable of providing visual feedback.

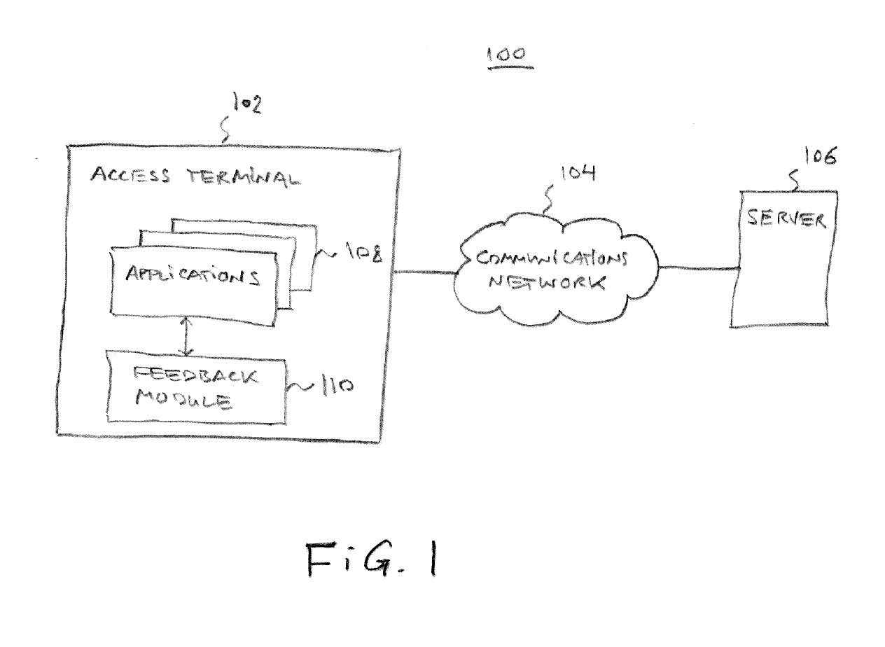

FIG. 1 is an example block diagram illustrating a system 100 for visual feedback in accordance with aspects of the present invention. The system 100 may include an access terminal 102 in communication with a server 106 via a communications network 104.

As shown in FIG. 1, the access terminal may include a plurality of software applications 108 (e.g., operating system, web browser, word processor, etc.) and a feedback module 110.

The feedback module 110 may be in a portable form that may be used not only for debugging websites, but for debugging or providing analysis and feedback on any type of software program. For example, the feedback module 110 may reside on a local hard drive (not shown), or be incorporated in a website in the form of a widget via server side, or it may be an add-on to a browser.

For example, when a user of the access terminal 102 is using a software program or reviewing/browsing a website and notices an error or anything in the program or website that the user would like to report, then the user may engage the area with a cursor, such as by right-clicking with a mouse on the area that is displaying the error. The feedback module 110 may detect the engagement, such as the right-click action, and display to a user an option to submit a feedback report.

If the user selects the option to submit a feedback report, the feedback module 110 may automatically capture a screen shot (or a subset of a screen, such as the area of the browser window, including any and all inputs entered by the user, such as selected radio buttons, check boxes, categories, etc.) and generate a workspace that includes the screenshot and a tool menu to facilitate annotating the screenshot. Along with the screenshot, the feedback module 110 may also capture the user's web browser type, operating system, IP address, website address (URL), screen coordinates (e.g., for proximity grouping of problems or for identifying issues with high resolution), and other information that may be valuable for communicating feedback related to the captured screenshot.

In the workspace, the feedback module 110 may automatically generate a field or design element, such as a call-out box, that is visually anchored or linked to the point or area designated by the user. The design element may allow the user to pinpoint where a problem exists on a web site or any image on their screen. For example, the design element may include a text field for including comments or annotations such that the user can enter a suggestion, complaint, or other information that can be categorized with additional fields (e.g., using drop down menus, etc.). The design element may also include other user input means, such as radio buttons, check boxes, categories, and additional text fields, that the user may use to provide additional information, such as meta data concerning the captured screenshot and the issue being reported. In addition, to the design element, the feedback module 110 may generate an input field separate from the design element and the screenshot, where the input field may include user input means, such as radio buttons, check boxes, categories, and text fields, that the user may use to provide additional information, such as meta data concerning the captured screenshot and the issue being reported.

The user may select additional areas in the screenshot ranging from a specific point (e.g., a pixel) to an area encompassing a part of or the whole of the screenshot. Selection of any point or area may trigger the feedback module 110 to provide the user with an option of whether to generate an additional design element related to the selected area. The user may also use the tool menu located in the workspace to have the feedback module 110 generate an additional design element. The user may also remove the design elements using an option in the tool menu. The design element may include an option to have the design element be visually linked to the selected area (e.g., via a line or an arrow) or to be displayed independently of the selected area.

Moreover, the feedback module 110 may provide an ability for the user to link a plurality of design elements to one or more areas, as well as link one design element to a plurality of areas.

The feedback module 110 may provide an ability for the user to move, relocate (e.g., click and drag) the design elements to any area within the workspace, as well as to resize the design elements to any dimension or shape (e.g., rectangle, circle, line, etc).

The feedback module 110 may also provide an ability for the user to highlight or black-out any information in the workspace. For example, if the screenshot contains sensitive or confidential information, the user may black-out that information using a tool that hides a designated area such that it is not visible to nor accessibly by a third party.

The feedback module 110 may also provide an ability for the user to rank the annotated areas by assigning values to the design elements that indicate whether the error is critical (e.g., broken script preventing an important feature from executing properly) or of low importance (e.g., graphical glitch causing minor aesthetic inconvenience).

Once the user identifies and annotates any desired areas or points, the user may trigger the feedback module 110 to submit the annotated workspace. The submission may be triggered by having the user click on or otherwise select a submit button located within the workspace or a feedback tool area in the workspace. When the submission is triggered, the feedback module 110 may convert the workspace into a portable format. For example, the feedback module 110 may unify the screenshot and the annotations into a single document or image. Thereafter, the feedback module 110 may locally store the workspace in its raw and portable formats in a local hard drive, for example. The feedback module may then transmit the workspace including all of the information captured and provided by the user (either in raw or portable format, as decided by the user) to a remote server, such as the server 106, for retrieval and analysis by a third party, such as a web developer, for example. The feedback module may also directly transmit the information to the server 106.

The feedback module 110 may also generate a work-ticket for transmission along with the workspace. The work-ticket may be utilized on the server-side to add the workspace to a work-ticketing system in a help-desk, or a project tracking software (e.g., JIRA, Footprints), for example, so that the workspace may be categorized and rank ordered based on an importance of the project that the workspace is related to and the level of criticality of the error being reported.

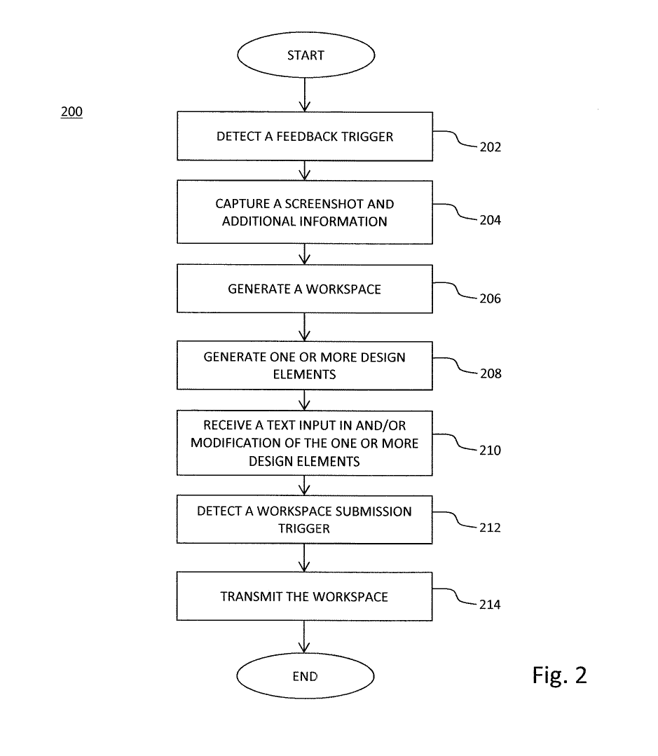

FIG. 2 illustrates an example flow diagram of a method 200 for visual feedback in accordance with aspects of this invention. As shown in FIG. 2, the process may begin in block 202, where a feedback trigger may be detected. For example, the feedback module 102 may detect a feedback trigger designating an area including at least one pixel.

In block 204, a screenshot and other information may be captured. For example, the feedback module 102 may automatically capture a screenshot including at least the designated area as well as other related information, such as user's web browser type, an operating system version, an IP address of the user, a website address (URL), and screen coordinates.

In block 206, a workspace may be generated. For example, the feedback module 102 may generate a workspace including the screenshot.

In block 208, one or more design elements may be generated. For example, the feedback module 102 may generate a design element, such as a call-out box, that is anchored to the designated area within the workspace.

In block 210, a text input may be received. For example, the feedback module 102 may receive a text input in and/or a modification of the design element.

In block 212, a workspace submission trigger may be detected. For example, the feedback module 102 may detect a workspace submission trigger, such as a user activating a workspace submission button.

In block 214, the workspace may be transmitted, and the process may end. For example, the feedback module 102 may transmit to the server 106 the workspace including the screenshot and the design element.

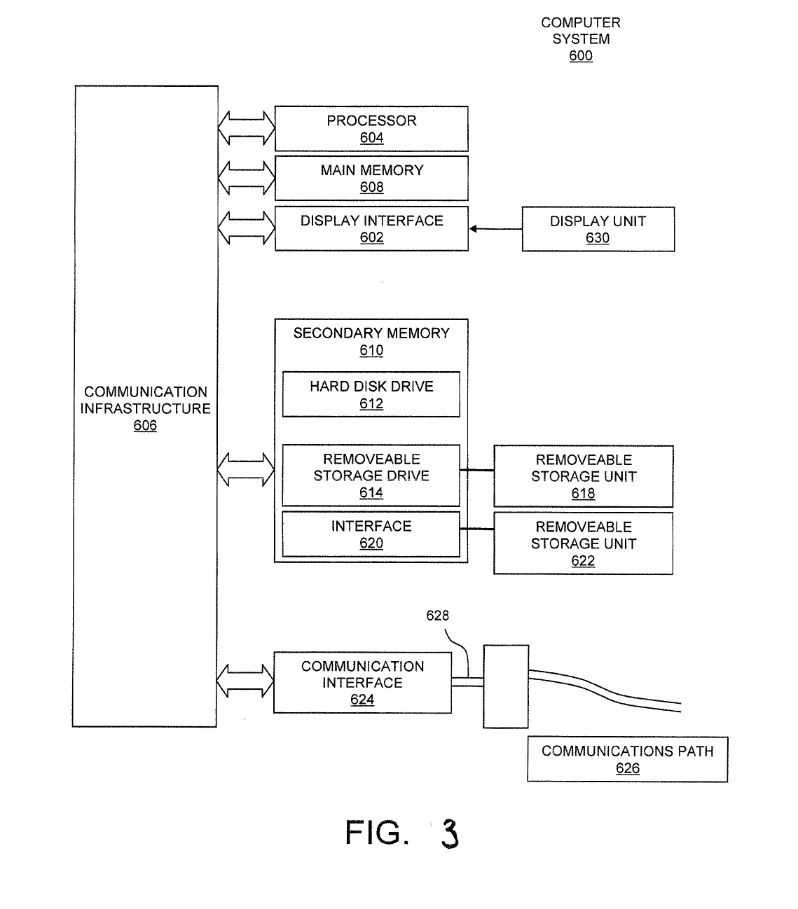

Aspects of the present invention, as well as programming functions performed via a separate terminal, may be implemented using a combination of hardware, software and firmware in a computer system. In an aspect of the present invention, the invention is directed toward one or more computer systems capable of carrying out the functionality described herein. An example of such a computer system 600 is shown in FIG. 3.

Computer system 600 includes one or more processors, such as processor 604. The processor 604 is connected to a communication infrastructure 606 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 600 can include a display interface 602 that forwards graphics, text, and other data from the communication infrastructure 606 (or from a frame buffer not shown) for display on a display unit 630. Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well-known manner. Removable storage unit 618, represents a floppy disk, magnetic tape, optical disk, etc., which is read by and written to removable storage drive 614. As will be appreciated, the removable storage unit 618 includes a computer usable storage medium having stored therein computer software and/or data.

Alternative aspects of the present invention may include a secondary memory 610 and may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628, which may be electronic, electromagnetic, optical or other signals capable of being received by communications interface 624. These signals 628 are provided to communications interface 624 via a communications path (e.g., channel) 626. This path 626 carries signals 628 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 614, a hard disk installed in hard disk drive 612, main memory 608, secondary memory 610, and signals 628. These computer program products provide software to the computer system 600. The invention is directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 610 to perform the features of the present invention. Accordingly, such computer programs represent controllers of the computer system 600.

In an aspect of the present invention where the invention is implemented using software, the software may be stored in a computer program product and loaded into computer system 600 using removable storage drive 614, hard drive 612, or communications interface 624. The control logic (software), when executed by the processor 604, causes the processor 604 to perform the functions of the invention as described herein. In another aspect of the present invention, the invention is implemented primarily in hardware using, for example, hardware components, such as application specific integrated circuits (ASICs). Implementation of the hardware state machine so as to perform the functions described herein will be apparent to persons skilled in the relevant art(s).

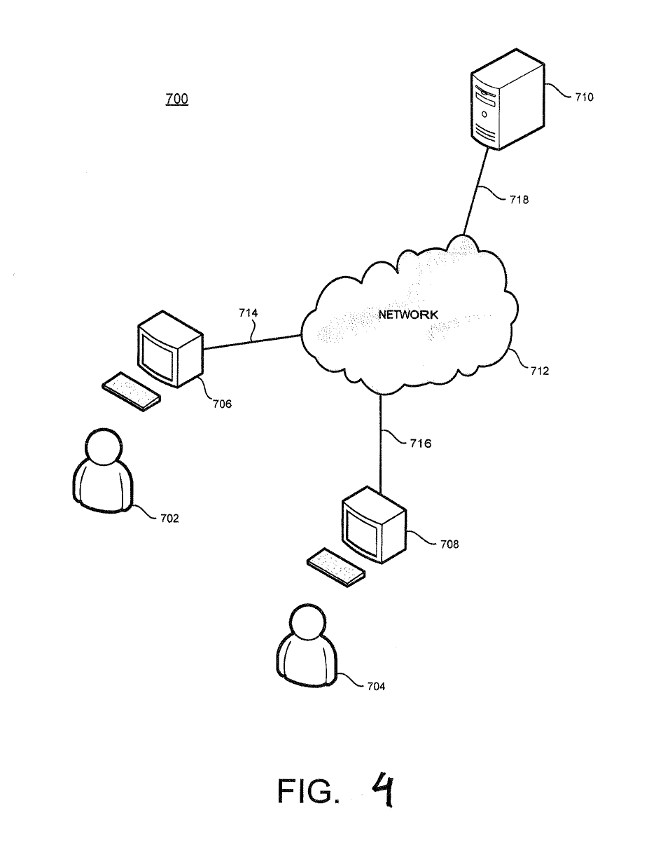

FIG. 4 shows a communication system 700 usable in accordance with aspects of the present invention. The communication system 700 includes one or more accessors 702, 704 (also referred to interchangeably herein as one or more “users” or “members”) and one or more terminals 706, 708. According to one aspect, data for use in accordance with the present invention is, for example, input and/or accessed by accessors 702, 704 via terminals 706, 708, such as personal computers (PCs), minicomputers, mainframe computers, microcomputers, telephonic devices, or wireless devices, such as personal digital assistants (“PDAs”) or a hand-held wireless devices coupled to a server 710, such as a PC, minicomputer, mainframe computer, microcomputer, or other device having a processor and a repository for data and/or connection to a repository for data, via, for example, a network 712, such as the Internet or an intranet, and couplings 714, 716, 718. The couplings 714, 716, 718 include, for example, wired, wireless, or fiberoptic links. According to another aspect, the method and system of the present invention may operate in a stand-alone environment, such as on a single terminal.

While the foregoing disclosure discusses illustrative aspects and/or embodiments, it should be noted that various changes and modifications could be made herein without departing from the scope of the described aspects and/or embodiments. Other aspects will be apparent to those skilled in the art from a consideration of the specification or from a practice of the invention disclosed herein. Furthermore, although elements of the described aspects and/or embodiments may be described in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for visual feedback, comprising:
detecting a first feedback trigger designating a first area including at least one pixel;
capturing a screenshot including at least the first area;
generating a workspace including the screenshot;
generating a first design element anchored to the first area within the workspace;
receiving an input in or a modification of the first design element;
detecting a workspace submission trigger; and
transmitting the workspace including the first area and the first design element to a remote server.

2. The method of claim 1, further comprising:
detecting a second feedback trigger designating a second area including at least one pixel;
generating a second design element anchored to the second area within the workspace;
receiving a text input in or a modification of the second design element; and
transmitting the workspace including the first area, the second area, the first design element, and the second design element to the remote server.

3. The method of claim 1, wherein capturing the screenshot further comprises capturing at least one of a user's web browser type, an operating system version, an IP address of the user, a website address (URL), and screen coordinates.

4. The method of claim 1, further comprising:
generating a work ticket; and
transmitting the work ticket along with the workspace including the first area and the first design element to a remote server.

5. The method of claim 1, further comprising receiving user supplied information associated with the screenshot, wherein the user supplied information includes meta data.

6. An apparatus, comprising:
a feedback module configured to:
detect a first feedback trigger designating a first area including at least one pixel;
capture a screenshot including at least the first area;
generate a workspace including the screenshot;
generate a first design element anchored to the first area within the workspace;
receive an input in or a modification of the first design element;
detect a workspace submission trigger; and
transmit the workspace including the first area and the first design element to a remote server.

7. A system, comprising:
means for detecting a first feedback trigger designating a first area including at least one pixel;
means for capturing a screenshot including at least the first area;
means for generating a workspace including the screenshot;
means for generating a first design element anchored to the first area within the workspace;
means for receiving an input in or a modification of the first design element;
means for detecting a workspace submission trigger; and
means for transmitting the workspace including the first area and the first design element to a remote server.

8. A computer program product comprising a non-transitory computer-readable medium having control logic stored therein for causing a computer to perform visual feedback, the control logic comprising:
code for detecting a first feedback trigger designating a first area including at least one pixel;
code for capturing a screenshot including at least the first area;
code for generating a workspace including the screenshot;
code for generating a first design element anchored to the first area within the workspace;
code for receiving an input in or a modification of the first design element;
code for detecting a workspace submission trigger; and
code for transmitting the workspace including the first area and the first design element to a remote server.
